(19) United States
(12) Patent Application Publication
(10) Pub. No.: US 2013/0040128 A1
(43) Pub. Date: Feb. 14, 2013

(54) HIGHLY CORROSION RESISTANT POLYUREA COMPOSITION

(71) Applicant: Carl E. Boddie, Houston, TX (US)

(72) Inventor: Carl E. Boddie, Houston, TX (US)

(21) Appl. No.: 13/208,647

(22) Filed: Aug. 12, 2011

(51) Int. Cl. B32B 27/06; B05D 3/00; B05D 7/24; B05D 7/02; C09D 175/02; C09D 5/08

(52) U.S. Cl. 428/319.3; 524/507; 427/385.5; 427/393.5

(57) ABSTRACT

Disclosed herein is a chemical resistant polyurea composition that may retain physical integrity even when continuously or semi-continuously exposed to a corrosive environment comprising alkalis or acids. The chemical resistant polyurea composition may be formed, in some embodiments, by a process including: reacting a polyalkadiene polyol with a polyisocyanate at a temperature and for a time sufficient to result in a polyurea prepolymer containing less than 5 wt. % NCO; admixing the polyurea prepolymer containing less than 5 wt. % NCO with a polyfunctional amine curing agent and at least one of a solvent, a UV absorber, an antioxidant, and a colorant to form a curable composition, wherein the polyurea prepolymer and the polyfunctional amine are admixed at a stoichiometric ratio, based on equivalents, in the range from about 1.03:1 to 1.08:1; and curing the curable composition to form the chemical resistant polyurea composition.

### FIELD OF THE DISCLOSURE

Embodiments disclosed herein relate generally to polyurea compositions based on polyalkadiene-based polyols. In another aspect, embodiments disclosed herein relate to polyurea compositions and coating produced therefrom that are resistant to attack and maintain their physical integrity when contacted with various acids or alkalis.

### BACKGROUND

Since the Iron Age, when society began to make metal implements and spanning structures, the problem of corrosion from environment elements has always been an Achilles heel. With the dawn of the Industrial Revolution and the advent of strong acids and alkalis to meet the needs of chemical synthesis and processing, the problem of corrosion has only been exponentially magnified.

To address corrosion issues, early chemistries were used to develop oil based air oxidized alkyl paints heavily laden with toxic metals. i.e., lead and chromium oxide. Later, the invention of reactive epoxy based coatings gained prominence as the premier “anti-corrosion” coating of choice. Coating systems based on epoxy and similar chemistries remain the standard, but problems remain with longevity against ultraviolet radiation and cracking from thermal expansion of metal substrates.

More recently, flexible coatings have found utility in applications involving abrasion resistance in pickup truck bed liners and “safety surfaces” for non-slip and impact absorption. Among the numerous flexible coatings available are polyurea and polyurethane coatings. The art of manufacturing polyurethane and polyurea coatings has been under development for the past thirty years. These types of coatings are usually made from prepolymers based on polyether polyols or polyester polyols (e.g., polycaprolactone polyols).

Maintaining the integrity of these polyurea and polyurethane coatings is problematic. For example, when bleach (sodium hypochlorite) is used for disinfection, as may be common in water parks, veterinary holding areas, vehicles for medical transport and industrial food processing areas, it often results in rapid degradation of the coating. As another example, in recent years, water parks have started using soft, non-absorbent, close-celled foams made from ethylene vinyl acetate having a protective rubber topcoat of the aforementioned polyurethane and polyurea coatings. These public swimming areas must maintain a constant level of chlorine (10 to 15 parts per million) to diminish the threat of infectious bacteria and virus. Actual case studies of these coatings have revealed failures caused by acid hydrolysis after only a few months of continuous immersion requiring costly repairs.

### SUMMARY OF THE CLAIMED EMBODIMENTS

It has been surprisingly discovered that polyurea and polyurethane compositions having minimal or limited ester linkages present in the backbone of the prepolymer, used in forming the polyurea or polyurethane coatings, drastically improves the chemical resistance of the final coating. For example, a typical prepolymer may be formed from a polyether- or a polyester-based polyol. The ester linkages present in the backbone of the resulting coatings remains hydrolysable in high acid and alkali conditions. In contrast, polyurea and polyurethane coatings according to embodiments disclosed herein are formed from prepolymers that preferably do not have or result in minimal ester linkages along the backbone of the coating, such as prepolymers formed using polyalkadiene polyols, including polybutadiene polyol, among others. The resulting polyurea and polyurethane coatings have excellent resistance to corrosive agents, and yet may remain highly flexible and U.V. resistant over long periods of time, and various embodiments may be capable of withstanding continuous immersion in salt water or chlorinated water, and/or may have mild resistance to corrosive acids and alkalis.

In one aspect, embodiments disclosed herein relate to a method of use, including: continuously or semi-continuously exposing a chemical resistant polyurea composition to a corrosive environment comprising alkalis or acids; wherein the chemical resistant polyurea composition is formed by a process comprising: reacting a polyalkadiene polyol with a polyisocyanate at a temperature and for a time sufficient to result in a polyurea prepolymer containing less than 5 wt. % NCO; admixing the polyurea prepolymer containing less than 5 wt. % NCO with a polyfunctional amine curing agent and at least one of a solvent, a UV absorber, an antioxidant, and a colorant to form a curable composition, wherein the polyurea prepolymer and the polyfunctional amine are admixed at a stoichiometric ratio, based on equivalents, in the range from about 1.03:1 to 1.08:1; and curing the curable composition to form the chemical resistant polyurea composition. In some embodiments, the polyurea prepolymer contains from about 2.0 wt. % to about 3.0 wt. % NCO.

In another aspect, embodiments disclosed herein relate to a process for forming a chemical resistant polyurea composition, the process including: reacting a polyalkadiene polyol with a polyisocyanate at a temperature and for a time sufficient to result in the polyurea prepolymer containing less than 5 wt. % NCO; admixing the polyurea prepolymer containing less than 5 wt. % NCO with a polyfunctional amine curing agent and at least one of a solvent, a UV absorber, an antioxidant, and a colorant to form a curable composition; and curing the curable composition.

In another aspect, embodiments disclosed herein relate to a chemical resistant polyurea composition, including: a reaction product of a polyurea prepolymer containing less than 5 wt. % NCO with a polyfunctional amine curing agent; and at least one of a solvent, a UV absorber, an antioxidant, and a colorant; the composition having sufficient chemical resistance to maintain at least 80% of its initial tensile strength, elongation, ductility, or impact resistance following continuous or semi-continuous exposure to a corrosive environment comprising alkalis or acids over a time period of at least 6 months. In another aspect, embodiments disclosed herein relate to a multilayer composite comprising at least one layer comprising a foam and at least one layer comprising the chemical resistant polyurea described above.

Other aspects and advantages will be apparent from the following description and the appended claims.

### DETAILED DESCRIPTION

In one aspect, embodiments disclosed herein relate to polyurea compositions based on polyalkadiene-based polyols. In another aspect, embodiments disclosed herein relate to polyurea compositions and coating produced therefrom that are resistant to hydrolysis when contacted with various acids or alkalis.

In more particular aspects, embodiments herein relate to a unique polyurea coating based on polyalkadiene-based polyols, such as polybutadiene-based polyols. The curable systems for producing the polyurea coatings are formulated to result in a polyurea coatings having excellent abrasion resistance, tensile strength, and elongation, and that can withstand the effects of strong mineral acids and corrosive alkalis. For example, polyurea coatings according to embodiments disclosed herein may be resistant to degradation normally caused to polyurea coatings by acids and alkalis such as hydrochloric acid (muriatic acid), sulfuric acid, nitric acid, hydrofluoric acid, sodium hydroxide (caustic soda), and sodium hypochlorite (chlorine bleach) at various strengths, and even up to full strength in some embodiments.

It has been surprisingly discovered that polyurea and polyurethane compositions having minimal or limited ester linkages present in the backbone of the prepolymer, used in forming the polyurea or polyurethane coatings, drastically improves the chemical resistance of the final coating. For example, a typical prepolymer may be formed from a polyether- or a polyester-based polyol. The ester linkages present in the backbone of the resulting coatings remains hydrolysable in high acid and alkali conditions. In contrast, polyurea and polyurethane coatings according to embodiments disclosed herein are formed from prepolymers that preferably do not have or result in minimal ester linkages along the backbone of the coating, such as prepolymers formed using polyalkadiene polyols, including polybutadiene polyol, among others. The resulting polyurea and polyurethane coatings have excellent resistant to corrosive agents, and yet may remain highly flexible and U.V. resistant over long periods of time, and various embodiments may be capable of withstanding continuous immersion in salt water or chlorinated water, and/or may have mild resistance to corrosive acids and alkalis. For example, an accelerated aging study of a polyurea coating according to embodiments disclosed herein indicated excellent retention of physical properties even after 30 days of continuous immersion at 140° F. in chlorinated water (pool water).

In other aspects, embodiments disclosed herein relate to a process for the formation of a curable composition. The process may include one or more of preparing a polyurea prepolymer and preparing a resin composition including a polyurea prepolymer and an amine curative, such as a polyfunctional amine curing agent. In other aspects, embodiments disclosed herein relate to using the above described resin or curable compositions in composites, coatings, adhesives, or sealants that may be disposed on, in, or between various substrates, before, during, or after curing of the composition.

In some aspects, the curable composition may be a self-curing composition at low to moderate temperatures. In other aspects, the curable composition may be cured using external heating. In other aspects, the stoichiometry of the prepolymer or the thermoset compositions may be controlled so as to result in a polyurea coating having the desired chemical resistance. In some embodiments, the curable compositions disclosed herein may be formed by admixing a polyurea prepolymer, an amine curing agent, and one or more of a solvent, a UV absorber, an antioxidant, and a colorant. In other embodiments, the curable composition may include fillers or other additives.

The polyurea coatings disclosed herein can be formulated to be quick or slow setting. Additionally, polyurea coatings disclosed herein may be applied with traditional equipment used in the application of ordinary industrial paints, as well as other common means of applying coatings.

Composites and curable compositions disclosed herein having improved chemical resistivity may include a polyurea prepolymer and an amine curing agent. The polyurea prepolymer may be formed by reacting a polyol with an polyisocyanate. The curable compositions may also include UV absorbers, antioxidants, colorants, fillers, and other additives. Each of these is described in detail below.

Polyol

As used herein, a “polyol” includes compounds containing active hydrogen in accordance with the Zerevitanov test described by C. R. Noller, Chemistry of Organic Compounds, Chapter 6, pages 121-22 (1957). The term “polyol” further means a compound having an average functionality greater than 1, preferably greater than 1.8, and most preferably about 2.0 or greater but less than about 6, preferably less than about 4, and most preferably about 3 or less. It is understood to include compounds that have (i) alcohol groups on primary, secondary, and tertiary carbon atoms, (ii) primary and secondary amines, (iii) mercaptans, and (iv) mixtures of these functional groups. Accordingly, the compositions disclosed herein can contain urea linkages, e.g., from the reaction of isocyanate functional groups with amines.

Polyols useful for preparing the prepolymer have a molecular weight of 62 to 10,000, preferably 200 to 5,000, and most preferably from 400 to 3,000.

As noted above, to arrive at the desired chemical resistance, it has been found that the polyurea prepolymer should have no or minimal ester linkages in the backbone of the prepolymer (minimal being herein defined as less than 5% of the backbone bonds; less than 4% in other embodiments; less than 3% in other embodiments; less than 2% in other embodiments; and less than 1% in yet other embodiments)). To result in the desired prepolymer, the preferred polyol is an oligomeric polyol, such as hydroxy terminated polyalkadienes, including polybutadienes and polyisoprenes. Other polyols having limited ester linkages may likewise be used.

In some embodiments, the oligomeric polyol is hydrogenated polyalkadiene polyols including hydrogenated polyisoprene and hydrogenated polybutadiene, the latter having no less than 19% by weight 1,2-butadiene addition. Commercially available hydrogenated polybutadiene diols may include KRATON L2203 from Shell Chemical, Houston, Tex., USA and POLYTAIL resins from Mitsubishi Chemical, Tokyo, Japan, among others.

Polyalkadiene polyols may be prepared from dienes which include unsubstituted, 2-substituted or 2,3-disubstituted 1,3-dienes of up to about 12 carbon atoms. Preferably, the diene has up to about 6 carbon atoms and the substituents in the 2-and/or 3-position may be hydrogen, alkyl groups having about 1 to about 4 carbon atoms, substituted aryl, unsubstituted aryl, halogen and the like. Typical of such dienes are 1,3-butadiene, isoprene, chloroprene, 2-cyano-1,3-butadiene, 2,3-dimethyl-1,2-butadiene, and the like. Hydrogenated derivatives of the polyalkadiene polyols may also be used.

Examples of the polyalkadiene-based polyols include: polybutadiene diol [diol of polybutadiene having a 1,2-vinyl structure and/or a 1,4-trans structure (butadiene homopolymer, and copolymer such as styrene butadiene copolymer, acrylonitrile butadiene copolymer)], and hydrogenation products of the same (hydrogenation ratio: for instance, 20% to 100%); and acryl-base polyols, such as copolymers of hydroxyalkyl (C: 2 to 6) (meth)acrylate [ethyl hydroxyethyl (meth)acrylate, etc.] and other monomers [styrene, alkyl (C: 1 to 18) (meth)acrylate, etc.]. Here, it should be noted that “(meth)acryl” refers to “acryl” or “methacryl.”

In some embodiments, the preferred polyol has a functionality of 2.0 and has 100% primary terminal hydroxyls, such as the polybutadiene polyol sold under the trade name KRASOL LBH-P-2000, manufactured by Cray Valley Corporation USA (Sartomer Corporation) or NISSO G-2000, manufactured by Nippon Soda Corporation, Japan. Other polybutadiene polyols may also be used with higher and lower molecular weights and/or functionalities to modify the properties of the finial product, such as POLY BD 45 HT LO or POLY BD R20LM (functionality of 2.3 -3.0) or KRASOL LBH-2040 (functionality of 4.0).

While it is desired to limit the ester linkages in the backbone of the prepolymer, other polyols may also be used in combination with the above polyalkadiene polyols in limited quantities, including polyester polyols and polyether polyols, among other diols and polyols known in the art. The amount and viability for each may depend upon the desired chemical resistivity and/or other desired physical and chemical properties of the resulting coatings and compositions.

Isocyanate

The isocyanate component of the adhesive composition comprises one or more of various suitable polymeric, monomeric or prepolymeric isocyanates.

Representative polyisocyanates (functionality of two or more) that can be used to form the prepolymers disclosed herein may include linear or branched, aliphatic, cycloaliphatic, araliphatic, heterocyclic or aromatic polyisocyanates. Suitable polyisocyanates are preferably aliphatic or cycloaliphatic isocyanates. The aromatic isocyanates are less preferred as they tend to discolor in ultraviolet light making them undesirable in outdoor applications.

Suitable diisocyanates include ethylene diisocyanate; 1,4-tetramethylene diisocyanate; 1,4 and/or 1,6-hexamethylene diisocyanate; 1,12-dodecane diisocyanate; cyclobutane-1,3-diisocyanate; cyclohexane-1,3- and 1,4-diisocyanate and mixtures of these isomers; 1-isocyanato-3,3,5-trimethyl-5-isocyanatomethyl cyclohexane; 2,4- and 2,6-hexahydrotolylene diisocyanate and mixtures of these isomers; hexahydro-1,3- and/or 1,4-phenylene diisocyanate; perhydro-2,4′- and/or 4,4′-diphenyl methane diisocyanate; 1,3- and 1,4-phenylene diisocyanate; 2,4- and 2,6-toluene diisocyanate and mixtures of these isomers; diphenyl methane-2,4′- and/or -4,4′-diisocyanate (H12MDI); naphthylene-1,5-diisocyanate; 1,3- and 1,4-xylylene diisocyanate, 4,4′-methylene-bis(cyclohexyl isocyanate), 4,4′-isopropyl-bis(cyclohexyl isocyanate), 1,4-cyclohexyl diisocyanate and 3-isocyanatomethyl-3,5,5-trimethylcyclohexyl isocyanate (IPDI); 2,4- and 2,6-toluene diisocyanate; diphenylmethane diisocyanate; hexamethylene diisocyanate; dicyclohexylmethane diisocyanate; isophorone diisocyanate; 1-methyoxy-2,4-phenylene diisocyanate; 1-chlorophenyl-2,4-diisocyanate; p-(1-isocyanatoethyl)-phenyl isocyanate; m-(3-isocyanatobutyl)-phenyl isocyanate and 4-(2-isocyanate-cyclohexyl-methyl)-phenyl isocyanate, isophorone diisocyanate, toluene diisocyanate and mixtures thereof. It is also possible to use aliphatic or aromatic diisocyanates of the type which are obtained by reacting excess diisocyanate with polyfunctional compounds containing hydroxyl or amine groups and which, in practical polyurethane chemistry, are referred to either as “modified isocyanates” or as “isocyanate prepolymers”.

The functionality of the polyisocyanate may range from about 2 to about 4 in some embodiments, and from about 2 to about 3 in other embodiments. The functionality of the isocyanate used may depend upon the desired properties of the final cured composition.

It is most desirable to produce a slow curing polymer that is easily applied with traditional paint equipment. For faster curing polymers, aromatic diisocyanates are used, such as toluene diisocyanate (TDI). For the fastest curing polymers, methylene diphenyl diisocyanate (MDI) may be used.

As noted above, the functionality of the isocyanate used should be in the range from about 2 to about 4. Compositions according to embodiments disclosed herein may also include some monofunctional isocyanates, where the amount and viability for each may depend upon the desired physical and chemical properties of the resulting coatings and compositions.

Polyurea Prepolymer

The polyurea prepolymer may be formed by reacting a polyalkadiene polyol with a polyisocyanate, each as described above.

To arrive at the desired chemical resistance, it has been found that the polyurea prepolymer should have minimal ester linkages in the backbone of the prepolymer. As such, it is preferred that the polyol component contains at least 90% polyalkadiene polyol or hydrogenated polyalkadiene polyol. In other embodiments, the polyol component may be at least 95% polyalkadiene polyol, at least 98% polyalkadiene polyol, at least 99% polyalkadiene polyol, or 100% polyalkadiene polyol.

The amounts of the polyol and isocyanate used to form the polyurea prepolymer affects the physical and chemical properties of the final polymer. Properties that can be varied include, but are not limited to, ductility, water uptake, tensile strength, modulus, abrasion resistance, minimum film-forming temperature, glass transition temperature, ultraviolet light resistance, and resistance to hydrolysis and color stability. In general, longer chain polyols tend to provide films made from the dispersions that are more ductile and have lower T_{g}, higher elongation, and lower tensile strength. In contrast, shorter chain polyols tend to provide films that have high modulus, greater tensile strength, and higher T_{g}. Aliphatic polyols tend to provide materials with decreased water uptake whereas diols containing heteroatoms in the backbone (e.g., polyether polyols) tend to have increased water uptake. The amount of water left in the film can affect its tensile and elongation properties. When resistance to hydrolysis is important, polyols should be selected that are hydrolytically stable, such as polyether and polysiloxane polyols, and polyols based on polyolefin backbones.

The polyol and isocyanate components should be admixed at about an equal number of equivalents, and are reacted at a temperature and for a time sufficient for the reaction to approach completion. In some embodiments, the prepolymer compositions according to embodiments disclosed herein may contain up to 5 wt. % or 10 wt. % unreacted NCO, as may be determined by procedures commonly used in the industry. In other embodiments, the prepolymer composition may contain less than about 5 wt. % unreacted NCO; less than about 3.5 wt. % NCO in yet other embodiments; less than about 3.0 wt. % NCO in other embodiments; from about 2.0 wt. % NCO to about 3.0 wt. % in other embodiments; and from about 2.5 wt. % NCO to about 3.5 wt. % NCO in yet other embodiments. The reaction temperature and time may depend on the particular polyol and isocyanate components used, and their reactivity. In some embodiments, the reaction temperature may be in the range from about 125° F. to about 225° F. in some embodiments, and in the range from about 150° F. to about 200° F. in other embodiments, such as in the range from about 175° F. to about 190° F.

The prepolymers disclosed herein may have an average functionality of 1.5 to 2.5, such as about 2.0. Additionally, the prepolymers may have a viscosity ranging from 500 to 20,000 mPa s at 25° C., such as in the range from about 1000 to 10,000 MPa s.

Of course, the prepolymer of the present invention may include catalysts, plasticizers/solvents, light stabilizers or UV absorbers, and antioxidants, as described below.

Amine Curing Agent

Suitable amine curing agents may include primary and secondary polyamines and adducts thereof, anhydrides, and polyamides. For example, polyfunctional amines may include aliphatic amine compounds such as isophorone diamine (available from Degussa Corp.), diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H. 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine (DETDA), may also be used.

In some embodiments, the preferred amine is DETDA, sold under the trade name

ETHACURE 100 and ETHACURE 300 (available from Albemarle). Other amines, both aromatic and aliphatic can be used as curatives depending on the application and desired properties of the cured coating.

Other Components

As noted above, prepolymer compositions and curable compositions according to embodiments disclosed herein may include antioxidants, UV absorbers, solvents, and colorants. Compositions disclosed herein may also include blocking agents, chain extenders, and other various components.

Solvents and/or plasticizers used in compositions disclosed herein may be reactive or non-reactive. Suitable solvents may include, for example, aromatic compounds such as toluene, xylenes, and ethylbenzene, as well as branched or straight-chain hydrocarbons, such as pentanes, hexanes, heptanes, and octanes, among other solvents. Toluene is a preferred solvent in some embodiments. In other embodiments, solvents useful in compositions disclosed herein may include ketones and similar compounds, examples of which may include cyclohexanone as well as butyl acetate, tert-butyl acetate, and sec-butyl acetate, among others.

Catalysts useful for promoting the reaction between the polyol and the isocyanate may include organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, among others. Illustrative examples include dibutyl tin dilaurate, bismuth nitrate, lead 2-ethylhexoate, lead benzoate, ferric chloride, antimony trichloride, stannous acetate, stannous octoate, and stannous 2-ethylhexoate.

Other solvents and catalysts can be used to adjust the desired propertied of the finished polymer, or to adjust application and drying times of the mixed coating (curable composition).

The addition of the blocking agents, such as 8-hydroxyquinoline and its derivatives, may provide an induction period which causes a reduction in the curing rate immediately after mixing of the components of the curable composition. The reduction in the curing rate results in lower initial tensile shear strengths and storage moduli immediately after mixing than those found in compositions that do not contain a blocking agent. Following the induction period the composition quickly cures so that the tensile shear strength and storage modulus are similar to those produced by compositions that do not contain the blocking agent. The blocking agent may be used in amounts in the range from about 0.001 to about 10 weight percent of the curable composition, such as in the range from about 0.01 to about 0.5 weight percent of the curable composition.

Chain extenders may include diamines and polyamines that, when blended with the polyol component and reacted with the isocyanate component, will not phase separate from the compositions. Examples of such amine compounds are ethylenediamine, polyoxypropylene diamine, 1,2- and 1,4-diaminocyclohexane in tans-, cis- or their mixture, dimethyldiaminodicyclohexylmethane, and 1,2-propanediamine. Still other chain extenders which may be used in the invention include amine containing alcohols or low molecular weight polyols. Examples are monoethanol amine, diethanol amine, and triethanol amine, tetra(2-hydroxypropyl) ethylenediamine available as Quadrol polyol (BASF Corporation).

Such chain extenders provide several benefits to the compositions of the invention including reaction with the isocyanate to improve flexibility, impact resistance and reaction rate. However, when selecting chain extenders and other components for use in compositions disclosed herein, one should be careful to limit or omit “OH” bearing curatives for use in the curative portion of the invention, thus decreasing or minimizing the formation of ester linkages, increasing the resistance of the cured composition to alkali and acids. Chain extenders may be used in an amount in the range from about 0 to about 20 weight percent of the curable composition, such as from about 3 to about 15 weight percent of the composition.

Ultraviolet (IV) absorbers and antioxidants are typically added to the prepolymer and/or curable compositions disclosed herein to improve long term weatherability and cosmetics of the cured coatings. Examples of useful antioxidants include TINUVfN 292, TINUVIN 328, and IRGANOX 1010, each manufactured by Ciba Corporation.

Optionally, fillers, fibers, plasticizers, pigments, colorants, flame retardants, processing aids such as thixotropic agents and internal lubricants, all of which are well known to those skilled in the art, can be added to the prepolymer or curable compositions disclosed herein. Various organic or inorganic fillers or fibers can be added to reduce the exotherm of the reaction of the two components, provide physical reinforcement, and/or reduce its cost. Fillers include such materials as talc, calcium carbonate, silica beads, calcium sulfate, aluminum trihydrate, ammonium polyphosphate, etc. The amounts of filler or other additives will vary depending on the desired application. For example, colorants and pigments may be used in an amount up to about 6% of the total weight of the resins (prepolymer plus amine curing agent) in the formulation.

Curable Compositions

Polyurea coatings resistant to acids and alkalis according to embodiments disclosed herein may be formed, for example, by admixing a polyurea prepolymer with a polyfunctional amine curing agent to form a curable composition, and curing the curable composition. The proportions of polyurea prepolymer and amine curing agent may depend, in part, upon the properties desired in the curable composition or coating to be produced, the desired cure response of the composition, and the desired storage stability of the composition (desired shelf life). The curable compositions and the composites described herein may be produced conventionally, accounting for the alteration in the isocyanate and epoxy resin compositions before they are cured.

For example, in some embodiments, a curable composition may be formed by admixing a polyurea prepolymer and an amine curing agent to form a mixture. The relative amounts of the polyurea prepolymer and the amine curing agent may depend upon the desired properties of the cured composition, as described above. In other embodiments, a process to form a curable composition may include one or more of the steps of forming a polyurea prepolymer, admixing a curing agent, and admixing additives, such as catalysts, solvents, antioxidants, and UV absorbers, among others.

The polyurea prepolymer and amine curing agent may be combined at a stoichiometric ratio, based on equivalents, in the range from about 0.5:1 to about 2:1 in some embodiments (prepolymer to amine curing agent). In other embodiments, the polyurea prepolymer and amine curing agent may be combined at a stoichiometric ratio, based on equivalents, in the range from about 0.75:1 to about 1.25:1; in the range from about 0.95:1 to about 1.1:1 in other embodiments; and in the range from about 1.03:1 to about 1.08:1 in yet other embodiments.

Variables to consider in selecting a curing agent and an amount of curing agent may include, for example, the epoxy resin composition (if a blend), the desired properties of the cured composition (flexibility, tensile properties, etc.), desired cure rates, as well as the number of reactive groups per curing agent molecule, such as the number of active hydrogen atoms in an amine.

In some embodiments, curable compositions according to embodiments herein, for producing chemical resistant polyurea coatings upon cure, may be formed by admixing a polyurea prepolymer containing less than 5 wt. % NCO with a polyfunctional amine curing agent and at least one of a solvent (viscosity control agent), a UV absorber, an antioxidant, and a colorant. In some embodiments, the polyurea prepolymer may be formed by reacting a polyalkadiene polyol with a polyisocyanate at a temperature and for a time sufficient to result in the polyurea prepolymer containing less than 5 wt. % NCO. In various embodiments, the polyalkadiene polyol may comprise at least one of a polybutadiene polyol and a polybutadiene diol, the polyisocyanate may comprise at least one of dicyclohexylmethane diisocyanate (H12MDI), isophorone diisocyanate (IPDI), methylene diphenyl diisocyanate (MDI), toluene diisocyanate, and tetramethyl xylylene diisocyanate (TMXDI), and the amine curing agent may comprise diethylene toluene diamine.

The curable compositions described above may be disposed on a substrate and cured. The substrate or object is not subject to particular limitation. As such, substrates may include metals, such as stainless steel, iron, steel, copper, zinc, tin, aluminum, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS or C glass; and silicon carbide or silicon carbide fibers containing titanium.

Composites and Coated Structures

In some embodiments, composites and other structures may be formed by curing the curable compositions disclosed herein. In other embodiments, composites may be formed by applying the curable composition to a substrate or a reinforcing material, such as by impregnating or coating the substrate or reinforcing material, and curing the curable composition.

The above described curable compositions may be in the form of a powder, slurry, or a liquid. After a curable composition has been produced, as described above, it may be disposed on, in, or between the above described substrates, before, during, or after cure of the curable composition.

For example, a composite may be formed by coating a substrate, such as a foam, with a curable composition. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on a substrate. For example, a substrate coated with a curable composition as described herein may additionally be coated with a second layer of the curable composition. Other multi-layer composites, formed by various combinations of substrate layers and curable composition layers are also envisaged herein.

In some embodiments, the heating of the curable composition may be localized, such as to avoid overheating of a temperature-sensitive substrate, for example. In other embodiments, the heating may include heating both the substrate and the curable composition.

Curing of the curable compositions disclosed herein may require a temperature of at least about 0° C., up to about 250° C., for periods of minutes up to hours, depending on the polyurea prepolymer, the amine curing agent, and catalyst, if used. Post-treatments may be used as well, such post-treatments ordinarily being at temperatures between about 50° C. and 200° C.

The resulting polyurea coatings have excellent resistance to corrosive agents, and yet may remain highly flexible and U.V. resistant over long periods of time, and various embodiments may be capable of withstanding continuous immersion in salt water or chlorinated water, and/or may have mild to excellent resistance to corrosive acids and alkalis. For example, such composites are highly chemical resistant, and may maintain a high degree of their physical integrity (such as >80% or 90% of the elongation, tensile strength, ductility, and/or impact resistance, etc.), even after exposure to chemical environments containing strong mineral acids and corrosive alkalis (e.g., hydrochloric “muriatic” acid 20%, sulfuric acid 70%, nitric acid 20%, hydrofluoric acid 48%, sodium hydroxide “caustic soda” 50% and sodium hypochlorite “chlorine bleach” (5-10%), and many others.

The curable compositions disclosed herein may be useful in composites containing ethylene vinyl acetate (EVA) foams or other foams comprising one or more polymeric base materials. For example, a closed-cell EVA foam may be circumferentially coated with curable compositions disclosed herein, and upon cure, resulting in an EVA foam having a protective polyurea coating. The cured polyurea coatings and foam composites according to embodiments disclosed herein may maintain their physical integrity when continuously or semi-continuously exposed to an aqueous environment comprising chlorine, such as an indoor or outdoor pool, for a time period of at least 6 months, in some embodiments; the physical integrity may be maintained for time periods of at least 12, 18, 24, 30, or 36 months or greater under similar conditions in other embodiments.

The curable compositions and composites described herein may be useful as adhesives, structural and electrical laminates, coatings, castings, structures for the aerospace industry, as circuit boards and the like for the electronics industry, windmill blades, as well as for the formation of skis, ski poles, fishing rods, and other outdoor sports equipment. The compositions disclosed herein may also be used in electrical varnishes, encapsulants, semiconductors, general molding powders, filament wound pipe, storage tanks, liners for pumps, and corrosion resistant coatings, among others.

### EXAMPLES

The finished coating consists of a premeasured amount of polyurea prepolymer

“Component A” and an amine curative mixture “Component B” that may be combined at the point of applications while providing a sufficient time to permit a complete application of the curable composition before polymerization begins.

Prepolymer Preparation

To make the “Component A” portion, a polyurea prepolymer was made in a closed reactor under a blanket of moisture free nitrogen gas. First, 2 moles of a diisocyanate were added to the reaction vessel. Next, 1 mole of a polyalkadiene diol was added to the reactor along with a small amount of catalyst to initiate the diisocyanate/polyol reaction. In addition, a small amount of solvent, such as toluene, and catalyst, such as dibutyltin dilaurate, were introduced into the reactor to lower the viscosity of the prepolymer and initiate the polymerization reaction.

The resulting mixture was agitated for four to five hours at 185° F. then analyzed for NCO % remaining and compared to theoretical to determine the extent/completion of the reaction process. The remaining NCO content for these examples was in the range from about 2% to about 3%. Finally, with the reaction complete, the mixture was cooled to 150° F. and the complete amount of diluent solvent was added to adjust viscosity and equivalent weight.

To make the “Component B” portion, a solvent was charged to a closed blending tank. Next, an amine curative was charged to the same mixing vessel. To finish the mixture, UV absorber and antioxidants were added to the mixture to improve long term weatherability and cosmetics of the cured coating.

Component A and Component B were combined at a stoichiometric ratio of 1.06 equivalents Part A to 1.0 equivalents of Part B.

The following examples (Example 1 and Example 2) were made using the procedure outlined above in a standard five (5) liter round bottom lab reactor under a nitrogen blanket with constant stirring at 120 rpm at 185° F. At the end of 5 hours, the samples were analyzed for % NCO to determine completion of the reaction. Then, the remaining portion of the diluent solvent was added and mixed for 30 minutes.

### Example 1

| Polyurea Prepolymer “Component A” | | | | | |
|---|---|---|---|---|---|
| % NCO following reaction 2.43 | | | Amine Curative “Component B” | | |
| | Equiv- | | | Equiv- | |
| Component | alents | Grams | Component | alents | Grams |
| VESTANET | 2.12 | 278 | Diethylene | 1.00 | 89 |
| H12 MDI | | | toluene | | |
| | | | diamine | | |
| | | | (DETDA) | | |
| KRASOL | −1.06 | 1124 | Toluene | | 469 |
| LBH-P-2000 | | | | | |
| Toluene | | 25 | TINUVIN 292 | | 27 |
| (reaction) | | | | | |
| Dibutyltin | | 0.04 | TINUVIN 328 | | 9.62 |
| Dilaurate | | | | | |
| Toluene | | 410 | IRGANOX | | 9.62 |
| diluent | | | 1010 | | |
| (added after | | | | | |
| reaction | | | | | |
| completion) | | | | | |
| TOTAL | 1.06 | 1837 | TOTAL | 1.00 | 604.24 |
| | | | (optional | | 92.23 |
| | | | colorant) | | |
| | | | Degussa 844 | | |
| | | | Molybdate | | |
| | | | orange | | |

### Example 2

| Polyurea Prepolymer “Component A” | | | | | |
|---|---|---|---|---|---|
| % NCO following reaction 2.43 | | | Amine Curative “Component B” | | |
| | Equiv- | | | Equiv- | |
| Component | alents | Grams | Component | alents | Grams |
| VESTANET | 2.12 | 278 | Diethylene | 1.00 | 89 |
| H12 MDI | | | toluene | | |
| | | | diamine | | |
| | | | (DETDA) | | |
| KRASOL | −0.53 | 562 | Toluene | | 363 |
| LBH-P-2000 | | | | | |
| Poly BD | −0.53 | 295 | | | |
| R20 LM | | | | | |
| Toluene | | 20 | TINUVIN 292 | | 27 |
| (reaction) | | | | | |
| Dibutyltin | | 0.03 | TINUVIN 328 | | 9.62 |
| Dilaurate | | | | | |
| Toluene | | 355 | IRGANOX | | 9.62 |
| diluent | | | 1010 | | |
| (added after | | | | | |
| reaction | | | | | |
| completion) | | | | | |
| TOTAL | 1.06 | 1510.03 | TOTAL | 1.00 | 498.24 |
| | | | (optional | | 76.21 |
| | | | colorant) | | |
| | | | Degussa 844 | | |
| | | | Carbon Black | | |

An accelerated aging study of the polyurea coatings of Examples 1 and 2 indicated excellent retention of physical properties even after 30 days of continuous immersion at 140° F. in chlorinated water (pool water).

A cured polymer sheet formed by curing a composition similar to that of

Examples 1 and 2, including a polyurea prepolymer (3.13 wt. % NCO) formed with dicyclohexylmethane 4,4′-diisocyanate polymerized with Krasol LBH-P-2000 (diol) cured with ETHACURE 100,was analyzed for physical properties (tensile properties were measured according to ASTM D412, and tear strength was measured according to ASTM D624). Cured polymer sheets were also immersed in various corrosive environments for an accelerated aging study (14 day or 30 day immersion at 140° F.), following which the samples were analyzed for physical properties. The averaged results from the baseline and aging studies are shown in the table below.

| | | | Tensile | % | | |
|---|---|---|---|---|---|---|
| | | | Strength | Elonga- | 100% | Tear |
| Sam- | Days Im- | Environ- | at Break | tion | Modulus | Strength |
| ple | mersed | ment | (psi) | at Break | (psi) | (lbsf/in) |
| Base- | — | — | 3186.8 | 446.4 | 695.8 | 595.1 |
| line | | | | | | |
| 1 | 30 | 25% NaOH | 4228.0 | 389.2 | 957.0 | 658.6 |
| 2 | 30 | 30% Nitric | 1179.5 | 250.8 | 767.1 | 317.5 |
| | | Acid | | | | |
| 3 | 30 | 32% HCl | 269.7 | 40.5 | — | 105.1 |
| 4 | 14 | 30% Nitric | 1148.7 | 173.9 | 894.4 | 338.2 |
| | | Acid | | | | |
| 5 | 14 | 48% HF | 2434.8 | 440.2 | 763.1 | 586.5 |
| 6 | 30 | 33.5% | 3394.3 | 432.4 | 800.7 | 674.9 |
| | | Sulfuric | | | | |
| | | Acid | | | | |
| 7 | 30 | Sodium | 2522.9 | 372.4 | 818.6 | 529.8 |
| | | Hypochlorite | | | | |
| | | (full | | | | |
| | | strength) | | | | |

As shown by the results in the table above, polyurea compositions according to embodiments disclosed herein may retain physical properties even after immersion in corrosive environments. By comparison, standard polyurethanes made from polyester or polyether polyols were completely destroyed after 48 hours in the heated test solutions.

Additionally, while it is noted that the physical properties after immersion in concentrated hydrochloric acid (32%) at 140° F. for 30 days was poor, similar studies with hydrochloric acid conducted over an immersion period of 14 days returned excellent results.

As described above, curable compositions disclosed herein may include polyurea prepolymers having minimal ester linkages along the backbone, advantageously resulting in coatings and compositions having a high degree of chemical resistance. Additionally, such coatings and compositions may advantageously maintain a high degree of their physical integrity upon repeated, semi-continuous, or continuous exposure to corrosive environments.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method of use, comprising
continuously or semi-continuously exposing a chemical resistant polyurea composition to a corrosive environment comprising alkalis or acids;
wherein the chemical resistant polyurea composition is formed by a process comprising:
reacting a polyalkadiene polyol with a polyisocyanate at a temperature and for a time sufficient to result in a polyurea prepolymer containing less than 5 wt. % NCO;
admixing the polyurea prepolymer containing less than 5 wt. % NCO with a polyfunctional amine curing agent and at least one of a solvent, a UV absorber, an antioxidant, and a colorant to form a curable composition, wherein the polyurea prepolymer and the polyfunctional amine are admixed at a stoichiometric ratio, based on equivalents, in the range from about 1.03:1 to 1.08:1; and
curing the curable composition to form the chemical resistant polyurea composition.

2. The method of claim 1, wherein the polyurea prepolymer contains from about 2.0 wt. % to about 3.0 wt. % NCO.

3. The method of claim 1,
wherein the polyalkadiene polyol comprises at least one of polybutadiene polyol and polybutadiene diol;
wherein the polyisocyanate comprises at least one of dicyclohexylmethane diisocyanate (H12MDI), isophorone diisocyanate (IPDI), methylene diphenyl diisocyanate (MDI), toluene diisocyanate, and tetramethyl xylylene diisocyanate (TMXDI); and
wherein the amine curing agent comprises diethylene toluene diamine.

4. The method of claim 1, further comprising disposing the curable composition on a substrate prior to the curing step.

5. The method of claim 4, wherein the substrate comprises an ethylene vinyl acetate polymer foam.

6. The method of claim 1, wherein the corrosive environment comprises an aqueous environment comprising chlorine.

7. The method of claim 6, wherein the aqueous environment is outdoors, resulting in exposure of the polyurea composition to UV radiation.

8. The method of claim 7, wherein the chemical resistant polyurea composition maintains its physical integrity for a time period of at least 12 months.

9. The method of claim 7, wherein the chemical resistant polyurea composition maintains its physical integrity for a time period of at least 24 months.

10. A process for forming a chemical resistant polyurea composition, the process comprising:
reacting a polyalkadiene polyol with a polyisocyanate at a temperature and for a time sufficient to result in the polyurea prepolymer containing less than 5 wt. % NCO;
admixing the polyurea prepolymer containing less than 5 wt. % NCO with a polyfunctional amine curing agent and at least one of a solvent, a UV absorber, an antioxidant, and a colorant to form a curable composition; and
curing the curable composition.

11. The process of claim 10,
wherein the polyalkadiene polyol comprises at least one of polybutadiene polyol and polybutadiene diol;
wherein the polyisocyanate comprises at least one of dicyclohexylmethane diisocyanate (H12MDI), isophorone diisocyanate (IPDI), methylene diphenyl diisocyanate (MDI), toluene diisocyanate, and tetramethyl xylylene diisocyanate (TMXDI); and
wherein the amine curing agent comprises diethylene toluene diamine.

12. The process of claim 10, wherein the temperature is in the range from about 125° F. to about 225° F.

13. The process of claim 10, wherein the reacting is performed in the presence of an organotin catalyst.

14. The process of claim 10, wherein the polyurea prepolymer contains less than 3.5 wt. % NCO.

15. The process of claim 10, wherein the polyurea prepolymer and the polyfunctional amine are admixed at a stoichiometric ratio, based on equivalents, in the range from about 0.95:1 to 1.1:1.

16. A chemical resistant polyurea composition, comprising a reaction product of a polyurea prepolymer containing less than 5 wt. % NCO with a polyfunctional amine curing agent; and
at least one of a solvent, a UV absorber, an antioxidant, and a colorant;
the composition having sufficient chemical resistance to maintain at least 80% of its initial tensile strength, elongation, ductility, or impact resistance following continuous or semi-continuous exposure to a corrosive environment comprising alkalis or acids over a time period of at least 6 months.

17. The composition of claim 16, wherein the polyurea prepolymer is formed by reacting a polyalkadiene polyol with a polyisocyanate at a temperature and for a time sufficient to result in the polyurea prepolymer containing less than 5 wt. % NCO.

18. The composition of claim 17, wherein the polyurea prepolymer contained from about 2.0 wt. % to about 3.0 wt. % NCO.

19. The composition of claim 18,
wherein the polyalkadiene polyol comprises at least one of polybutadiene polyol and polybutadiene diol;
wherein the polyisocyanate comprises at least one of dicyclohexylmethane diisocyanate (H12MDI), isophorone diisocyanate (IPDI), methylene diphenyl diisocyanate (MDI), toluene diisocyanate, and tetramethyl xylylene diisocyanate (TMXDI); and
wherein the amine curing agent comprises diethylene toluene diamine; and
wherein the polyurea prepolymer and the polyfunctional amine are present in the reaction product at a stoichiometric ratio, based on equivalents, in the range from about 0.95:1 to 1.1:1.

20. A multilayer composite comprising at least one layer comprising a foam and at least one layer comprising the chemical resistant polyurea composition of claim 16.
